(19) United States
(12) Patent Application Publication
(10) Pub. No.: US 2014/0047701 A1
(43) Pub. Date: Feb. 20, 2014

(54) WORD-BASED LOCK AND KEY

(71) Applicant: Wordlock, Inc., Santa Clara, CA (US)

(72) Inventor: Todd Basche, Los Altos, CA (US)

(21) Appl. No.: 13/908,983

(22) Filed: Jun. 3, 2013

Related U.S. Application Data
(60) Provisional application No. 61/655,408, filed on Jun. 4, 2012.
(60) Provisional application No. 61/714,084, filed on Oct. 15, 2012.

(51) Int. Cl. B23P 19/04

(52) U.S. Cl. CPC B23P 19/04
USPC 29/592

(57) ABSTRACT

A method and system to enable the easy identification of a key which corresponds to a particular lock is disclosed. The key and lock of a mating key-based lock assembly, from a production of like assemblies having a finite number of mating key/lock configurations, are marked with the same indicia selected from a set of indicia comprised of words, alphanumeric characters, symbols, colors and shapes, or combinations thereof, which set of indicia is larger than the number of unique key/lock configurations in the production of like key and lock assemblies.

### CROSS REFERENCE TO RELATED APPLICATIONS

This non-provisional patent application claims the benefit of and priority to Provisional U.S. Patent Application No. 61/655,408, titled WORD-BASED LOCK AND KEY, filed Jun. 4, 2012, and Provisional U.S. Patent Application No. 61/714,084, titled WORD-BASED LOCK AND KEY, filed Oct. 15, 2012, which are hereby incorporated herein in their entirety by reference thereto.

TECHNICAL FIELD

Embodiments of the present invention are directed to locks, and more particularly to locks opened with a key.

### BACKGROUND

Many conventional locks are designed to be opened with a key specifically configured for the locking device within the lock. Users often have a very difficult time locating which key is the proper key for a particular lock. Systems have been developed to help the user match keys with locks. For example, users can put colored rings or bumpers on a key for a lock to distinguish that key from other keys. This color coding of the keys, however, does not indicate which lock goes with the key, so the user still must remember which lock is opened by the color coded key. Many users have a drawer in their house with multiple keys in it. It is impossible for them to know which key opens which lock. When a user has multiple keys and locks, or when multiple people use multiple locks and keys, even the color coding system does not adequately correlate the keys to the locks.

### SUMMARY

The present invention is directed to a lock and key system that overcomes drawbacks experienced in the prior art and provides other benefits.

### BRIEF DESCRIPTION OF THE DRAWINGS

FIG. 1 is a schematic elevation view of a key-based lock assembly with a lock and key that each includes a common keyword unique to that key-based lock assembly.

FIG. 2 is a list of only a few of millions or more of potential keywords that can be used on the key and lock of FIG. 1.

FIGS. 3-5 are schematic elevation views of a lock system with lock and key assemblies of other embodiments, including padlocks, discus locks, and bike locks, etc.

### DETAILED DESCRIPTION

The present disclosure describes a key-based lock system that includes a lock and key assembly, wherein a lock and corresponding key each includes one or more common indicia, including a keyword unique to that key-based lock assembly, in accordance with certain embodiments of the present invention. Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below.

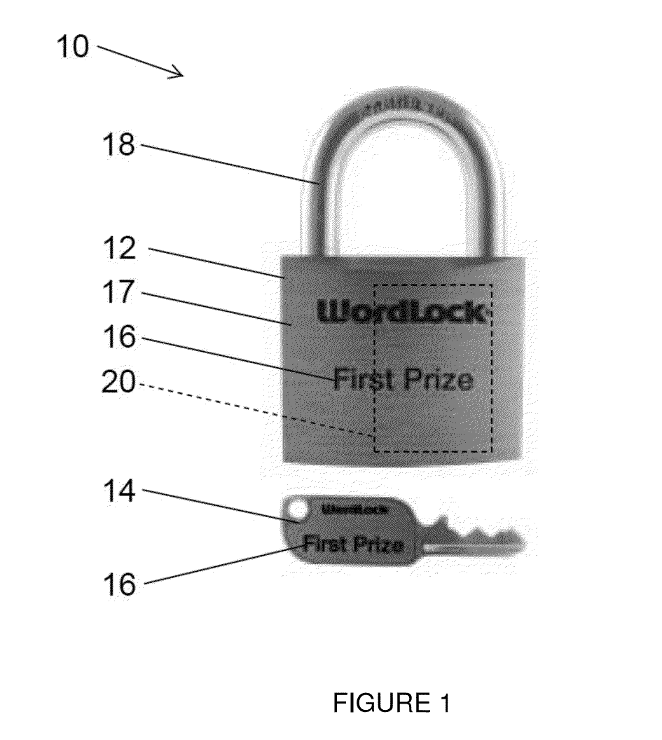

Referring to FIG. 1, the system has a key-based lock assembly 10 that includes a lock 12 and a mating key 14 that each includes a common keyword 16 unique to that key-based lock assembly 10. The lock 12 includes a housing 17, a shackle 18 connected to the housing and an internal locking device 20 that releasably engages the shackle to allow it to move between open and closed positions. The internal locking device 20 can have a conventional construction with a plurality of tumblers or pins arranged, so that the mating key 14 can be inserted into the locking device 20 so as to move the tumblers or pins to an unlocking position, thereby releasing the shackle 18 from the locking device 20. This unlocks the lock and allows the shackle 18 to be moved from the locked closed position to an unlocked open position.

When conventional key-based locks are manufactured, the manufacturer may builds hundreds of thousand of locks and mating keys, but there are typically only about 1500 different locking devices within those hundreds of thousands of padlocks. This means that one single key can open many of the manufactured locks such that the keys and locks are actually not unique. These conventional key-based padlocks, however, will typically be distributed throughout large geographic areas, so there may be a low likelihood that a holder of a key in that area would find a different lock that could also be opened with his or her key. If, however, the geographic area is relatively small, then there is a higher likelihood that one key could open multiple locks in the same small geographic area. The bottom line is that the key and lock combinations are not unique.

The system of the present disclosure provides the illustrated key-based lock assembly 10 having a unique key and lock combination, independent of the number of locking devices made by the manufacturer. This is accomplished by using a unique combination of indicia, such as including keywords. with each key and lock combinations, so as to provide unique key-based lock assemblies. In an embodiment in accordance with the present disclosure, the key 14 for each assembly 10 includes a word-based keyword 16 on the key 14. That same keyword 16 is also provided on the particular lock 12 that mates with the key 14. In the illustrated embodiment, the keyword 16 is engraved, stamped, etched, formed, or otherwise permanently affixed to the key 14 and/or to the lock 12. In other embodiments, the keywords 16 may be printed or otherwise applied onto the key 14 and/or the lock 12.

The use of the keyword 16 allows a user to easily and visually determine which key 14 goes with which lock 12. The user need only match the keywords 16 between the keys 14 and locks 12. Accordingly, if the keyword 16 on a key 14 is “First Prize” (see, FIG. 1), then the user knows that the key 14 will open the lock 12 displaying the same “First Prize” keyword 16.

The key-based lock assembly 10 of the present disclosure is manufactured so that the same keyword 16 is never used on multiple locks 12 that include the same locking device 20. For example, if a lock manufacturer uses 1500 different locking devices 20, each identified with a part number, such as part numbers 0001-1500. The keywords 16, the locks 12 and associated part number of the locking devices 20 in the locks are tracked so that the same keyword 16 is never used on more than one lock 12 that included locking devices 20 with the same part number. Preferably a keyword 16 is never used more than once, which may render unnecessary correlating and tracking the keywords 16 and locking devices 20. This means that the combination of the keyword 16 and the mating key 14 and lock 12 (with the selected locking device 20) will be unique and not duplicated, even when the manufacturer produces one million, ten million, twenty million or more locks with the keywords. This also means that a user having a key 14 having a particular keyword 16 on it will only be able to open the one mating lock 12 with the matching keyword 16. This lack of duplication between the keywords, keys and locks results in an increased security for the user.

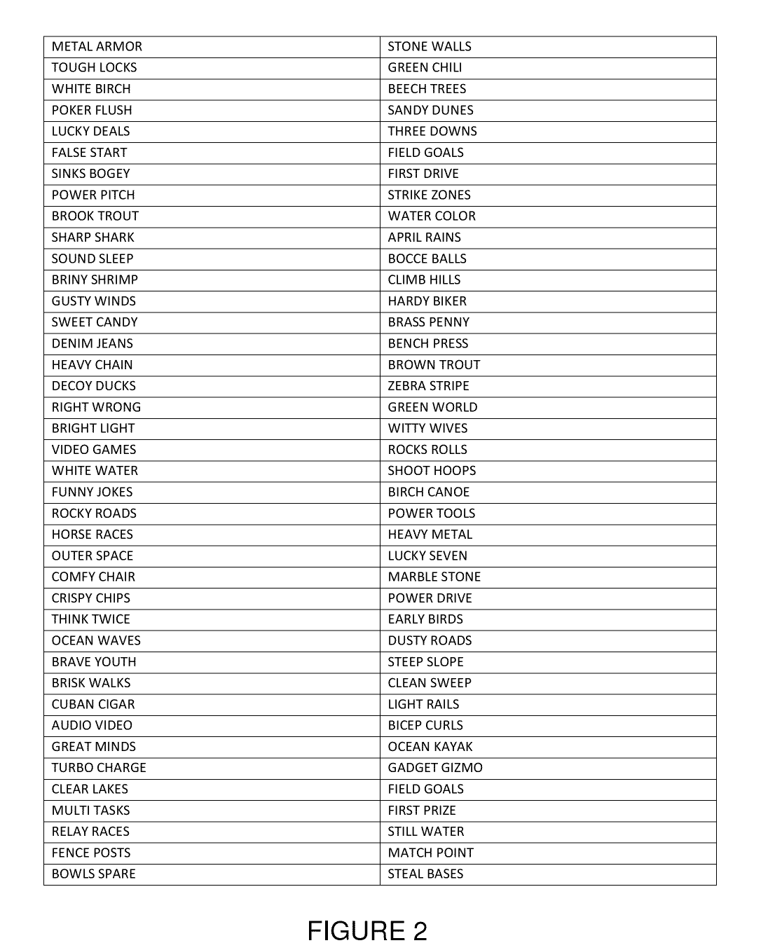

FIG. 2 is a list very short list (approximately 80 keywords) of potentially millions or billions of potential keywords 16 that can be used on the key 14 and lock 12. While the keywords 16 illustrated in FIG. 2 are made up of a pair of English words, the keywords 16 can be single words or can be a combination of three or more words. The keywords 16 can be abbreviations, acronyms, or other terms. The keywords 16 can be Instant or Text Messaging acronyms or Text Messaging shorthand (e.g., the terms listed at the www.netlingo.com website). In one embodiment, a keyword 16 can have recognizable combinations of letters such as 4EVER (meaning “forever”), 2NITE (meaning “tonight”), and 14AA41 (meaning “one for all and all for one”), etc. In yet another embodiment, the keywords 16 can be or include letters and symbols forming a rebus, such as “I♡YOU” or “I♡2EAT.” The keywords 16 can also be in any selected language. The keywords 16 can also be a combination of numbers and one or more words, such as “24FROGS”. Other embodiments can use other arrangements of words with or without numbers. Accordingly, the keywords 16 have an incredible versatility, and a “virtually unlimited” number of keywords 16 can be used with the keys 14 and locks 12.

In one embodiment, the locks 12, keys 14, and associated keywords 16 can be correlated, recorded, and/or registered, to track the key-based lock assemblies 10. This registration program can be used to allow a properly authenticated user to obtain a replacement key 14 or a lock 12 simply by identifying the keyword 16 on the lock 12. This registration process, of course, has adequate safeguards so a replacement key 14 will be provided only to the proper, authenticated user associated with the particular key-based lock assembly 10.

The keywords 16 on the lock 12 and the key 14 define a first indicia usable by a person to quickly and easily identify which key corresponds to which lock. The system of the present disclosure provides the illustrated lock assembly 10 that also has a key 14 with a unique shape as compared to conventional lock keys. In the illustrated embodiment, the head 15 of the key 14 has a visually distinctive shape that allows a user to visually and/or tactilely differentiate the key 14 from other conventional keys that, as an example, the user may have on one or more key rings. In other embodiments, other portions of the key 14 can have the visually or tactilely differentiatable shape that acts as the indicia for differentiating the key from other conventional keys. Accordingly, the key shape is a second indicia that, alone or in combination with the keyword 16 (i.e., the first indicia), enables a person to quickly and easily identify which key corresponds to which lock.

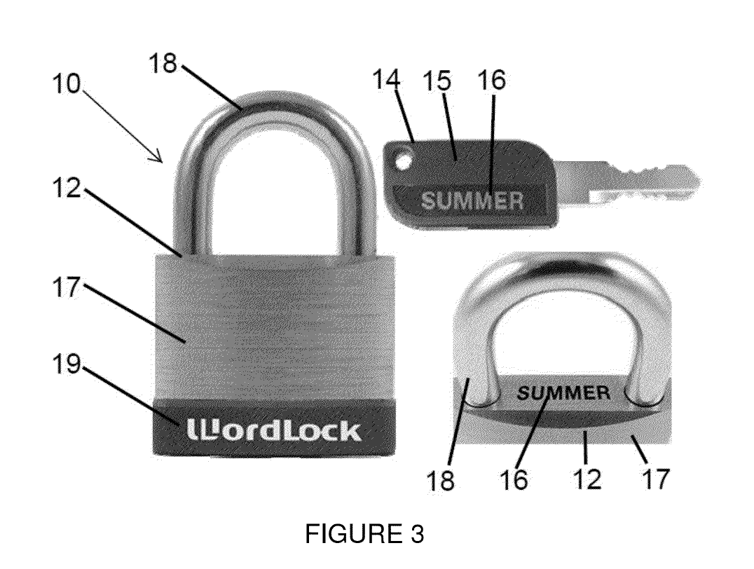

The system of the present disclosure provides the lock assembly 10 illustrated in FIGS. 3-5 that uses color as yet a third indicia to correlate the key 14 with the mating lock 12. At least a portion of the key 14 has a distinguishable color (e.g., red, blue, yellow, orange, purple, green, black, white, etc.) or a combination of colors in an identifiable pattern (e.g., stripes, dots, geometric shapes, images, etc.). In the illustrated embodiment, only the head 15 of the key 14 is provided with the identifiable, distinguishable color. The color on the head, 15 can be provided by the actual material forming the head (i.e., a colored, plastic head), a permanent cover applied to the head, 15, paint, dye, or other coloration permanently affixed to the head 15.

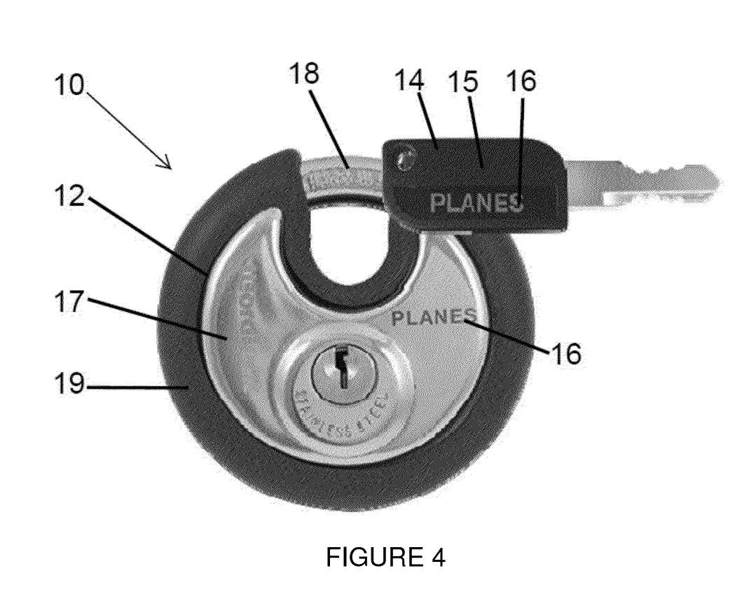

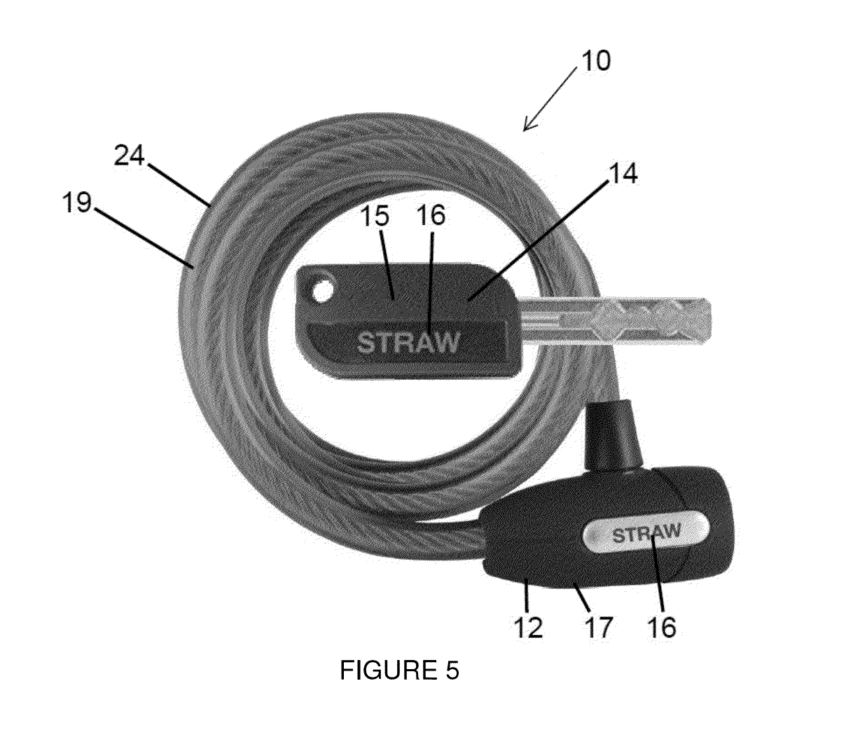

The lock 12 that mates with the key 14 also includes at least a portion 19 having the same identifiable, distinguishable color as on the mating key 14. The identifiable, distinguishable colors are selected so as to differentiate them from conventional key/lock sets. As seen in FIG. 3, the colored portion 19 of the lock 12 is a colored boot permanently affixed to the bottom of the illustrated padlock 12. In FIG. 4, the colored portion 19 is a durable, permanent colored cover member disposed about the periphery of the illustrated discus lock 12. In FIG. 5, the colored portion 19 is a colored, permanent cable cover 24 of the illustrated bike lock 12. In yet other embodiments, other colored portions 19 can be provided on the lock 12, such as a distinguishably colored shackle, lock body, or selected surface on the lock. The lock assemblies 10 illustrated in FIGS. 3-5 have at least two colors, at least one of which is a distinguishable, identifiable color indicator that corresponds with the distinguishable, identifiable color indicator on the mating key 14. Accordingly, the identifiable, distinguishable color on at least a portion of the key 14 and a portion of the lock 12 provides a third indicia that, alone or in combination with the keyword 16 (i.e., the first indicia) and/or the key shape (i.e., the second indicia) enables a person to quickly and easily identify which key corresponds to which lock.

The key-based system of the present disclosure provides a lock and key assembly that uses the three-indicia identification system (key-shape, color, and keyword) to greatly increase the user's ability to quickly and accurately locate the key that mates with a selected lock. For example, a user may own a hundred key-based locks, including ten of the key-based lock assemblies 10, which include four different colors (red, blue, green and purple), and the user desires to open the lock assembly 10 of FIG. 3 that has a green key/lock and the keyword “SUMMER.” Accordingly, the user can quickly visually and/or tactilely identify the ten uniquely shaped keys 14 (as described above). The user can then identify the key(s) 14 with the green color that matches the green colored portion on the lock 12 to be open. If the user has more than one key 14 with the matching green color, the user than matches the unique keyword 16 (“SUMMER”) on the green key 14 to the same keyword 16 (“SUMMER”) on the green lock 12. As a result, the user is guaranteed to have the correct key for the lock using the three-indicia identification system very quickly without ever having to insert the key into the lock to “try it” and determine whether he/she has the right lock. Accordingly, the system allows the user to very quickly identify and locate the correct key 14 for its mating lock 12 with perfect accuracy.

The key-based system of the present disclosure provides a lock and key assembly that uses a two-indicia identification system (color and keyword) to greatly increase the user's ability to quickly and accurately locate the key that mates with a selected lock. For example, a user may own a fifty key-based locks, including eight of the key-based lock assemblies 10, which include four different colors (red, blue, green and purple), and the user desires to open the lock assembly 10 of FIG. 4 that has a red disc lock 12 and the keyword “PLANES.” Accordingly, the user can quickly and easily visually identify the key(s) 14 with the red color that matches the red colored portion on the disc lock 12 to be open. If the user has more than one key 14 with the matching red color, the user than matches the unique keyword 16 (“PLANE”) on the red key 14 to the same keyword 16 (“PLANES”) on the red disc lock 12. As a result, the user is guaranteed to have the correct key for the lock using the two-indicia identification system very quickly without ever having to insert the key into the lock to “try it” and determine whether he/she has the right lock. Accordingly, this two-indicia color/keyword identification system allows the user to very quickly identify and locate the correct key 14 for its mating lock 12 with perfect accuracy.

The system with the two and three-indicia identification system for the key-based lock assembly 10 also provide an apparent increased level of security against duplication during manufacture, because the likelihood of ever having an unintentional duplication of the same keyword, color and shape on the identical keys and locks is incredibly small. For example, a lock manufacturer making the key-based lock assemblies 10 of the present disclosure may have an inventory of locks and keys with 1000 different lock tumbler arrangements. If the manufacturer used a list of 10,000 different keywords and randomly assigned keywords from the list to randomly selected key-lock sets, and the manufacturer also randomly assigned a color from a selection of five different colors for the key-lock assemblies 10, the likelihood of ever duplicating a key/lock assembly with the same lock tumbler arrangement, the same keyword, and the same color is incredibly miniscule. The result is that, even by random selection of the components, a lock manufacturer will likely never make the same key/lock assembly twice. This means that the owner of the key-based lock assembly 10 of the present disclosure would virtually never encounter another person with the same key-based lock assembly 10 with an identical key that could open the owner's lock.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

1-10. (canceled)

11. A process for the manufacture of a production of key-based lock assemblies having a finite number of unique mating key and lock configurations, said lock assemblies having indicia thereon to facilitate the identification of mating key and locks, comprising:
applying the same indicia to the key and lock of each mating key and lock configuration, wherein the indicia applied to said key and lock configurations are selected from a finite set of different indicia comprised of words, alphanumeric characters, symbols, colors and shapes, and combinations thereof, and wherein said set of applied indicia is larger in number than the number of unique mating key and lock configurations in the production, and different indicia from the set of indicia is applied to each different mating key and lock configuration within said production.

12. The process of claim 1, wherein the indicia applied to the key and lock of each unique mating key and lock assembly comprises only words or alphanumeric characters.

13. The process of claim 1, wherein the indicia applied to the key and lock of each unique mating key and lock assembly comprises a color in combination with a word or alphanumeric characters.

14. The process of claim 13, wherein the color is applied to the keys of said key and lock assemblies by making the keys, or a portion thereof, of material having said color.

15. The process of claim 13, wherein the color applied to the locks of said key and lock assemblies by affixing a cover having said color to at least a portion of said locks.

16. The process of claim 13, wherein the locks of said key and lock assemblies are cable locks and the color is applied to the locks by applying a material having said color to the locks' cables.

17. The process of claim 14, wherein the color is applied to the locks of said key and lock assemblies by affixing a cover having said color to at least a portion of the locks.

18. The process of claim 14, wherein the locks of said key and lock assemblies are cable locks and the color is applied to the locks by applying a material having said color to the locks' cables.
